(19) United States
(12) Patent Application Publication
(10) Pub. No.: US 2003/0056100 A1
(43) Pub. Date: Mar. 20, 2003

(54) Method and system for authenticating a digitized signature for execution of an electronic document

(76) Inventor: Rodney Beatson, Severna Park, MD (US)

Correspondence Address: ROSENBERG, KLEIN & LEE, 3458 ELLICOTT CENTER DRIVE-SUITE 101, ELLICOTT CITY, MD, 21043, US

(21) Appl. No.: 09/951,621

(22) Filed: Sep. 14, 2001

(51) Int. Cl. H04L 9/00

(52) U.S. Cl. 713/176

(57) ABSTRACT

A method and system of authenticating a digitized signature for execution of an electronic document is provided. The method includes the steps of: entering an electronic signature (12), storing the electronic signature (14), determining a secret sign (16), storing a template of value ranges associated with predetermined features of the secret sign (18), handwriting of a secret sign (24), measuring the predetermined feature values of the handwritten secret sign (26), comparing those measured values to the stored value ranges (28), and attaching a digital representation of the user's valid signature to an electronic document responsive to authentication of the handwritten secret sign (30).

### BACKGROUND OF THE INVENTION

1. Field of the Invention

The subject invention relates to a method and system for authenticating a digitized signature for execution of an electronic document. In particular, the present invention directs itself to a method including the steps of: establishing and storing a digital representation of a user's valid signature, establishing a secret sign known only to the user, creating a template of value ranges for predetermined features of the secret sign, electronically storing the secret sign template, measuring values of the predetermined features of a hand-written secret sign, comparing the measured values with the value ranges of the secret sign template to authenticate the secret sign, and appending a copy of the digital representation of the user's valid signature to an electronic document responsive to authentication of the secret sign. More particularly, this invention directs itself to a method of authenticating a digitized signature for execution of an electronic document having an encrypted secret sign template for providing additional security for both the addition of electronic signatures to electronic documents and for providing access to computerized systems.

Further, the subject invention relates to a system for authenticating a digitized signature of an electronic document. In particular, the present invention directs itself to a signature entry device for receiving and digitizing a user's valid signature in electrical communication with storage media for electronically storing the digital representation of the user's valid signature and the secret sign template value ranges. Additionally, this invention directs itself towards a system for authenticating digitized signature for an electronic document having a logic processor in electronic communication with the secret sign entry device and the template storage medium for comparing the secret sign and the saved set of value ranges. Still further, this invention directs itself to a method of authenticating access to an electronic system. The method including the creation of a template of value ranges for predetermined features of a secret sign, and providing access to the electronic system responsive to authentication of a handwritten secret sign using the template.

2. Prior Art

Systems for the verification and storage of digital representations of a user's signature are well known in the art. In general, such prior art systems include a signature entry device in electrical communication with a computerized storage system where the entered digital signature is compared with a set of stored value ranges for a pre-recorded set of authorized signatures. Although the systems are often coupled with further security measures, such as encryption of the stored value ranges, and additional forms of user entry, such as passwords and personal identification numbers, the systems suffer from the possibilities of forgery and stolen personal information.

The present method and system for authenticating a digitized signature for execution of an electronic document includes a further step, and corresponding equipment, for the handwritten entry of a secret sign known only to the user. Thus, even if an unauthorized user is capable of forging the authorized user's signature, and has stolen personal information, such as a personal identification number, the unauthorized user still does not know the authorized user's secret sign and will not be able to recreate the handwritten secret sign.

One such prior art system is shown in U.S. Pat. No. 5,987,232. This reference is directed towards a verification server for use in authentication on networks. In this system, authentication data is sent from an application client to a verification server through an application server. The authentication data can be passwords, membership numbers, or physical quantities such as signatures. This system does not, however, include a secret sign entry for authentication.

Another such prior art verification system is shown in U.S. Pat. No. 6,091,835. This reference is directed toward a method and system for transcribing electronic affirmation. This system accepts and records all types of biometric, infometric, and cryptographic signatures or affirming acts, such as those created by passwords, secret cryptographic keys, unique secret numbers, biometric records such as handwritten signatures or other biometric information, or multi-recording of affirming statements. Although the system may accept electronic signatures and secret information, such as passwords, or personal identification numbers, the system does not include the entry and authentication of a handwritten secret sign known only to the user in order to execute an electronic document with an appended digital signature.

Great Britain Patent 1,480,066 is directed towards an apparatus for recognizing handwriting. This system records an entered electronic signature or drawn sign whose display is not inhibited, and compares measured values with a stored template of value ranges. However, this system does not provide for the authentication of the secret sign in order to append a digital representation of a signature to an electronic document for execution.

U.S. Pat. No. 6,154,841 is directed toward a digital signature method and communication system. This system uses a common public parameter, such as a prime number, and a registered signature for verification of identity. The common public parameter and the signature may be changed by a user to provide a secure digital representation of a signature which accompanies a message sent from the user to a verifier system. The system, however, does not include a secret sign known only to the user, verification of which allows the digital representation of the user's signature to be appended to an electronic document.

Another prior art electronic signature system is shown in U.S. Pat. No. 5,493,614. This reference is directed toward a private signature and proof system. This system provides for the cryptographic encoding of an electronic signature or other similar electronic proof of authentication. This system, however, does not include a secret sign known only to the user, which, when verified, will attach a digital representation of the user's signature to an electronic document.

None of the prior art provides for a combination of elements forming a method and system of authenticating a digitized signature for execution of an electronic document including the steps and means for recording a secret sign known only to the user and comparing measured values of the handwritten secret sign to a set of stored value ranges for execution of an electronic document with an appended digital representation of the user's signature.

### SUMMARY OF THE INVENTION

The present invention provides for a method and system for authenticating a digitized signature for execution of an electronic document. The method includes the steps of: establishing and storing a digital representation of the user's valid signature, establishing a secret sign known only to the user and creating a template of value ranges for predetermined features of the secret sign, electronically storing the template, handwriting the secret sign on the signature entry device, measuring values of the predetermined features of the handwritten secret sign and comparing those measured values with the value ranges stored in the secret sign template, and, upon validation of the secret sign, appending a copy of the digital representation of the user's valid signature to an electronic document responsive to an authentication signal. The associated system includes a signature entry device for receiving and digitizing the user's valid signature, a signature storage medium in electrical communication with the signature entry device, a secret sign entry device and associated template storage medium for electronically storing a set of value ranges for predetermined features of the secret sign, and a logic processor for comparing the secret sign with the set of value ranges.

It is a principle objective of the subject method and system for authenticating a digitized signature for execution of an electronic document to provide a secure system allowing only authorized users to append a digital representation of an electronic signature to an electronic document.

It is a further objective of the subject method and system for authenticating a digitized signature for execution of an electronic document to provide a forgery-proof means of electronic authorization.

It is a further objective of the subject invention to provide a system for electronic authentication which is not susceptible to false authentication resulting from the theft of a user's password, personal identification number, or other personal identifying information.

It is an important objective of the present invention to provide a method and system of authenticating a digitized signature for execution of an electronic document requiring the entry and authentication of a handwritten secret sign known only to the user for purposes of electronic authentication and system access.

It is yet another object of the present invention to provide a method of authenticating access to an electronic system.

### BRIEF DESCRIPTION OF THE DRAWINGS

FIG. 1 is a flowchart illustrating the steps of authenticating a digitized signature for execution of an electronic document;

FIG. 2A is a schematic representation of the system for authenticating a digitized signature for execution of an electronic document;

FIG. 2B is a schematic representation of an alternate configuration for the system for authenticating a digitized signature for execution of an electronic document;

FIG. 2C is a schematic representation of another configuration for the system for authenticating a digitized signature for execution of an electronic document;

FIG. 3 is a perspective view of an information entry system used in the electronic authentication system; and

FIG. 4 is a flowchart illustrating the steps of forming a secret sign template.

### DESCRIPTION OF THE PREFERRED EMBODIMENTS

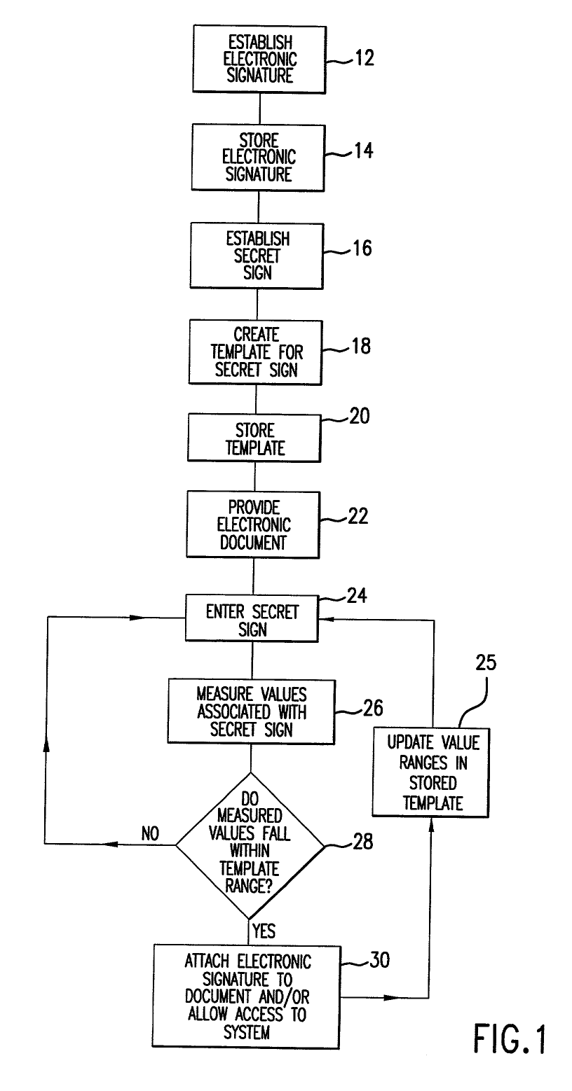

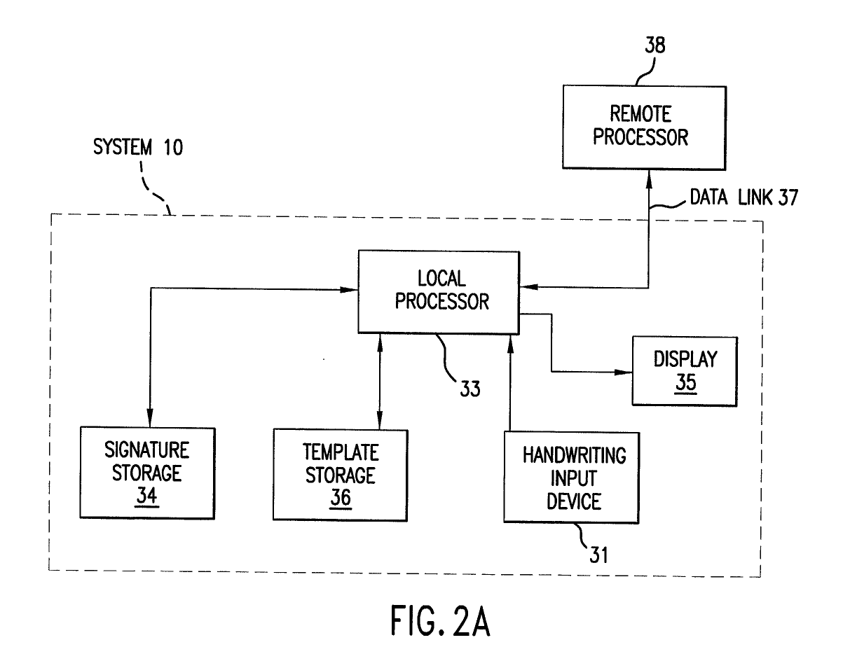

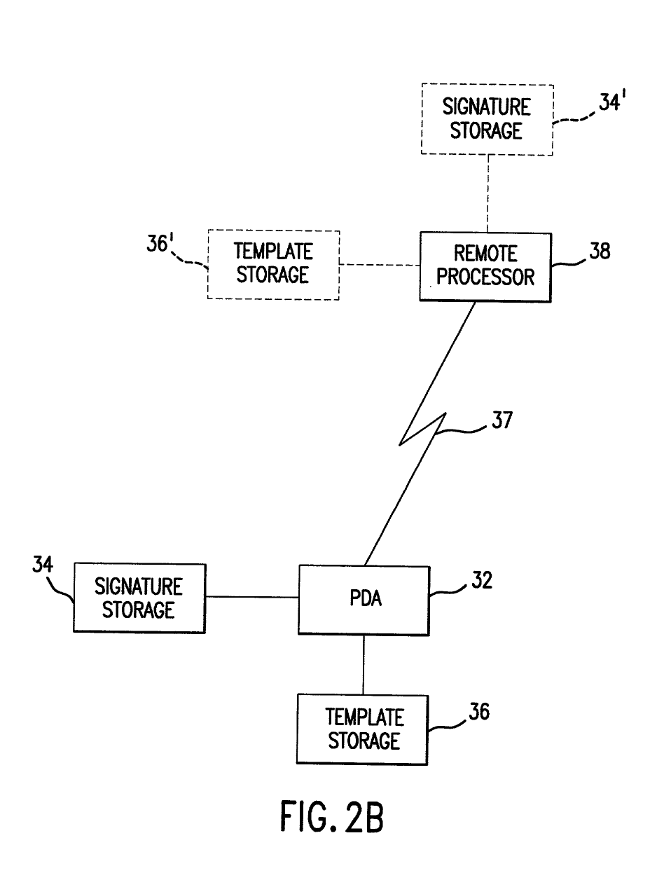

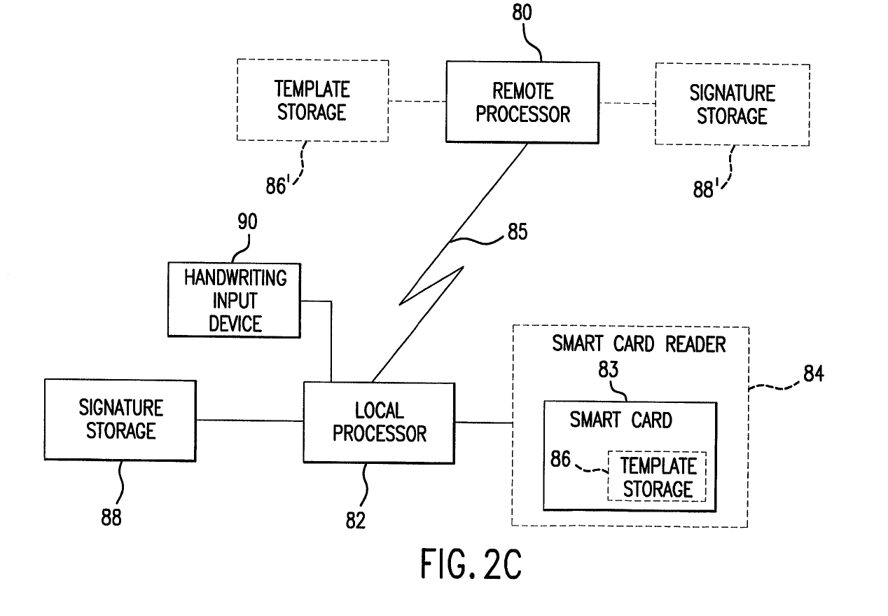

FIG. 1 is a flow chart of the method of the instant invention illustrating the steps of authenticating a digitized signature for execution of an electronic document. In the first step, step 12, a digital representation the user's signature is established. As will be described below, the user's signature may be entered on a personal digital assistant (PDA) 32, as shown in FIG. 2B of the Drawings, a digitizer, or through any other means of direct computer input of combined positional and pressure values.

At step 14, shown in FIG. 1, the digital representation of the signature is stored. The particular type of storage medium used for storing the digital representation of the signature is not important to the inventive concepts embodied herein and may be a magnetic medium, RAM memory, a smart card, a remote storage server, or the like. The next step in the method, step 16, is to establish a secret sign. The secret sign is any handwritten sign known only to the user, such as a symbol, word, personal identification number, or any combination thereof.

At step 18, a secret sign template is created. The template includes a multiplicity of value ranges for predetermined features of the secret sign. These predetermined features may include, but are not limited to, coordinate values and pressure values for the secret sign within a certain tolerance, or error, limit. Preferably, functions of the predetermined features, such as functions of the coordinate values or functions of the pressure values, are stored in the template. Examples of functions of varied feature values will be explained in further detail in following paragraphs.

At step 20, the template is stored. Here again, the particular type of storage medium is not important to the inventive concept, and the medium may be a magnetic storage medium, RAM memory, a smart card, a remote storage server, or the like. At step 22, an electronic document is provided for the attachment of the electronic signature The electronic document may be an electronic contract, e-mail, or any other document requiring a valid user's signature. Additionally, the electronic document may comprise a credit or debit card receipt or other authorization for an electronic financial transaction.

At step 24 in FIG. 1, the secret sign is entered. The secret sign may be entered through any direct user handwriting entry device, such as PDA 32, shown in FIG. 2B. It is particularly important that when the user enters the secret sign on the device, such as PDA 32, the device does not display what the user is writing and the stylus used is an “inkless” stylus. There should be no visual feedback of the handwritten entry. This is so onlookers cannot view what the user is writing and gain knowledge as to the user's secret sign. At step 26, the predetermined features established in the template for the secret sign (see step 18) are measured.

There are many features which can be used to compare electronic signatures. The best features are those showing greatest discrimination between authentic and forged signatures. There have been many experiments to compare authentic signatures with forged signatures, for which, at least, the appearance (if not also the manner of signing) would be known to the forger. There have been no such experiments recorded on secret signs where there would be little foreknowledge available.

Making use of the central limit theorem in statistics, which can be extended to show that if there are sample means μᵢ, where i=1 . . . n, from each of n independent variables, so long as n is sufficiently large, the summation of all μᵢ/n is normally distributed with specific mean and variance. The minimum value of n is generally accepted to be 15, and so, for feature sets greater than or equal to 15, statistical theory based on normal distributions can be applied.

One method of choosing a set of features is to proceed as follows:

First, define an initial feature set (f₁ . . . fₙ). Each feature should be intuitively chosen to be independent of each of the others.

Secondly, undertake an experiment to capture the feature data of different authors submitting authentic signs. Then capture equivalent data from a set of “forgers” attempting to reproduce/guess the authentic signs of the original authors.

Third, analyze mismatch scores by comparing sign feature values from both authentic and forged signs with established templates from a set of authentic signs. Suppose the authentic mismatch score for feature i and sign j is Aᵢⱼ and we have Na such authentic samples. We further suppose the forged mismatched scores are Fᵢⱼ and we have Nf of these forged samples. We further suppose that there are n measured features for each sign.

Next, we establish independence of the initial feature set by calculating the correlation matrix between features. The correlation coefficients rᵢₖ between feature i and feature k can be estimated as follows:

$${r}_{ik} = \frac{C ( {A}_{ij} , {A}_{kj} )}{\sqrt{V ( {A}_{ij} ) \cdot V ( {A}_{kj} )}}$$

Correlation coefficients above 0.4 or below −0.4 are generally considered to be significant and feature combinations generating values outside this interval should generally be avoided by eliminating the least discriminating feature or, perhaps, combining the correlated features in some manner.

Next, we calculate the set of weights, wᵢ which maximizes discrimination between authentic and imposter signs. As an example, it can be determined by solving the simultaneous equations:

$${w}_{1} {S}_{11} + {w}_{2} {S}_{12} + … + {w}_{n} {S}_{1 n} = {d}_{1}$$

$${w}_{1} {S}_{21} + {w}_{2} {S}_{22} + … + {w}_{n} {S}_{2 n} = {d}_{2}$$

$$⋮$$

$${w}_{1} {S}_{n1} + {w}_{2} {S}_{n2} + … + {w}_{n} {S}_{nn} = {d}_{n}$$

$$where$$

$${d}_{p} = {\sum }_{j = 1 … Na} \frac{{A}_{pj}}{Na} - {\sum }_{j = 1 … Nf} \frac{{F}_{pj}}{Nf}$$

$$and , \\ {S}_{pq} = {\sum }_{j = 1 … Na} [ {A}_{pj} - {\sum }_{j = 1 … Na} \frac{{A}_{pj}}{Na} ] \cdot [ {A}_{pj} - {\sum }_{j = 1 \cdot Na} \frac{{A}_{qj}}{Na} ] + {\sum }_{j = 1 \cdot Nf} [ {F}_{pj} - {\sum }_{j = 1 … Nf} \frac{{F}_{pj}}{Nf} ] \cdot [ {F}_{pj} - {\sum }_{j = 1 … Nf} \frac{{F}_{qj}}{Nf} ]$$

Choosing at least 15 features from the initial set whose discriminating weights have greatest power and for which there are no mutual correlation coefficients outside the range r₁ where −0.4>r>0.4, provides us with a set of feature values.

Some features, which might emerge from such an analysis, are: ratio of time in contact to total time for writing a signature, the total time to write a signature, the ratio of the sum of y turning point times to the total time, the ratio of the sum of x turning point times to the total time, the ratio of x speed to (x+y) speed, the ratio of y forehand speed to (x+y) speed, the aspect ratio, the ratio of forehand intervals to total points, the ratio of y distance to y standard deviation, the ratio of x distance to x standard deviation, the ratio of y forehand movement to y standard deviation, the ratio of x forehand movement to x standard deviation, ratio of y turning point x-position sum to x standard deviation, ratio of x turning point y-position sum to y standard deviation, and the ratio of new contact x-position summation to x standard deviation. Discriminating weights would be calculated from the experiment referred to above.

At step 28, the measured values of the predetermined features for the entered secret sign are compared with the value ranges established in the template. If the measured values fall within the templates ranges, the process moves on to step 30, at which point the digital representation of the signature is attached to the document. If the measured values do not fall within the template's ranges, the system may send the process back to step 24 to re-entering the secret sign. Alternatively, authentication failure may cause an alert signal to be generated (not shown) or may deny the user entry to the system (not shown). The output of an alert signal and/or denial of further access to the system may also result after a predetermined number of attempts to re-enter the secret sign in step 24.

The predetermined feature values of the secret sign stored in the template may include stylus coordinate values. The stylus coordinate values are generated and measured when the secret sign is entered on a digital handwriting entry device, such as a personal digital assistant. For purposes of security and to save storage space, the predetermined features may be stored in the template as functions of the stylus coordinate values. Further predetermined feature values stored in the secret sign template may include pressure values, or functions thereof, corresponding to those of the stylus coordinate values. The pressure values are provided as an output of the handwriting entry device. Storing values that are functions of stylus coordinate and pressure values create a template that cannot be decoded to recreate or reveal a user's secret sign.

In addition to storing functions of stylus coordinate values in the secret sign template, the value ranges stored in the secret sign template may be encrypted. Further, the value ranges may be updated with each entry of an authenticated secret sign. As shown in FIG. 1, after the digital representation of the electronic signature is attached to the document in step 30, the value ranges stored in the template at step 20 are updated in step 25, with the new value ranges measured by the entry of the latest secret sign in step 24. The process then passes to step 24 for subsequent entry of the secret sign to authenticate attachment of another digital representation of the electronic signature.

The secret sign template may further include user identification data, such as personal information including an account number or other information, an authentication code, or any other necessary or helpful information to reduce the likelihood of false authentication. The secret sign template may also include an electronic time stamp denoting the time of secret sign entry and/or latest update. The electronic time stamp is appended to the template at step 28 of FIG. 1, every time that the secret sign is accepted as authentic, but alternatively would be included in other steps.

The secret sign template further may include a count of the number of times the value ranges of the template have been updated. The secret sign template can be stored on a smart card, a personal digital assistant, a local computer system, such as a personal computer, a remote storage server, or any other form of electronic or magnetic storage media.

System 10 for the authentication of a digitized signature for execution of an electronic document is shown in FIG. 2A. System 10 includes a processor 33 in electrical communication with a display 35, a hand-writing input device 31, a template storage 36, and a signature storage 34. Additionally, the processor 33 is in electrical communication with a remote server 38 through a data link 37. The processor 33, display 35, handwriting input device 31, template storage 36, and signature storage 34, forming system 10, may be incorporated in a personal digital assistant or other handheld computing device.

FIG. 2B illustrates a configuration of system 10 wherein processor 33, display 35, and handwriting input device 31, of FIG. 2A, are incorporated in a personal digital assistant (PDA) 32. PDA 32 is an electrical communication with signature storage 34. Signature storage 34 may be onboard memory of the PDA 32, a removable memory medium or device, or signature storage 34 may be embodied in a the storage medium of a remote computer system. PDA 32 is in electrical communication with template storage 36 for storage of the value ranges of the predetermined features of the secret sign.

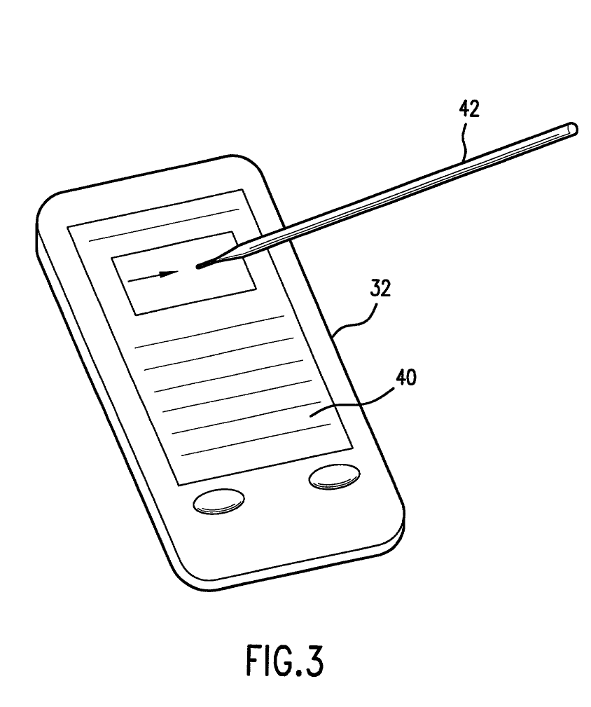

PDA 32 includes a program that instructs the user to enter a secret sign. The display associated with that instruction may include a signature line or box as a reference for the user. However, it is a key feature of the authentication system that there is no display of the secret sign, as it is entered or at any time thereafter. In order to increase security, the signature entry device does not display the secret sign as it is being written on the face of the signature entry device. As illustrated in FIG. 3 of the drawings, as the stylus 42 is drawn across screen 40 of PDA 32, the handwritten entry remains invisible. The secret sign or the digital representation thereof is never available to any processor or stored in any media. Where the template is located on a remote processor, only values of the predetermined features are transmitted from the input device, preferably in encrypted form.

Template storage 36 may be onboard memory of PDA 32, a storage medium or storage device of a remote system, a removable memory medium or device, or any other form of electronic or magnetic storage. Signature storage 34 and template storage 36 may reside in the same storage medium.

In the system of FIG. 2B, PDA 32 is shown coupled to remote processor 38 by data link 37. Data link 37 may be a wireless, “hard wired” or combined hard wired and wireless data path coupling PDA 32 with remote processor 38. PDA 32 is in electrical communication with signature storage medium 34 and template storage 36. The secret sign template, established and stored in steps 18 and 20 and updated in step 25 of FIG. 1, is stored in template storage 36 but may also be stored on the remote processor 38. Storage on both template storage 36 and remote processor 38 allows for backup of the template. The secret sign may be entered (step 24 of FIG. 1) on PDA 32 and the comparison of the measured values to the stored template value ranges (step 28 of FIG. 1) takes place within the PDA 32. If PDA 32 determines the secret sign to be valid when the electronic signature stored in signature storage medium 34 is appended to the stored electronic document as in step 30 of FIG. 1.

In an alternative arrangement, remote processor 38 may perform the comparison between the measured values associated with the entry of the secret sign and the values stored in the secret sign template. Further, the signature storage and template storage may be located in direct communication with remote processor 38, as shown in FIG. 2B, template storage 36′ may either replace template storage 36 or may hold a redundant copy of the template. Similarly signature storage 34′ may replace signature storage 34 or may hold a redundant copy of the digital representation of the user's signature.

In yet another arrangement shown in FIG. 2C, local processor 82 is electrically coupled to signature storage 88, a handwriting input device 9, and a smart card 83 through smart card reader 84. Local processor 82 is further coupled to a remote processor 80, through data link 85 which may be a wireless connection, hard wired connection, or a combination thereof. Here, smart card 83 includes the template storage 86. Template storage 86 may reside on smart card 83 itself, or may be in electrical communication therewith. The secret sign template may be further stored on remote processor 80 for backup thereof, and verification of the secret sign (step 28 of FIG. 1) is performed within the processor 82 itself.

In an alternative configuration, the smart card 83 may include processor 82 and can be used in place of remote processor 80 for comparison of measured values within the value ranges of the secret sign template. Alternatively, the comparison of the measured values with the value ranges stored in the secret sign template may be performed by smart card reader 84. The smart card reader 84 would be in electrical communication with the signature entry device, which in combination with processor 82 may be part of a PDA.

Remote processor 38 of FIG. 2B or remote processor 80 of FIG. 2C may represent a local host, such as a personal computer, work station, cash register system, or the like. Further, template storage 86′ and signature storage 88′ of FIG. 2C may either replace template 86 and signature storage 88, respectively, or may store redundant copies of the template and electronic signature therein.

Both the digital representation of the signature and the measured values of the secret sign template may be stored on smart card 84 of FIG. 2C, RAM memory, on a remote storage server, such as remote processor 38 of FIG. 2B or remote processor 80 of FIG. 2C, or any other storage system or media.

In addition to the attachment of the digital representation of the signature to a document (step 30 of FIG. 1), system 10 may provide access to an otherwise restricted electronic system. This may be used to replace or in addition to passwords or other electronic entry systems presently used in personal digital assistants, automatic teller machines, electronic funds transfers, and the like. The verification of the correctly entered secret sign can be used to grant user access to a computer network, credit/debit card system, a personal digital assistant, or any other electronically secured computerized system. For this application, the method of FIG. 1 remains the same, except for step 30. Step 30 would now transmit a signal (authentication signal) to the secure system to provide access thereto.

The creation of the secret sign template (step 18 in FIG. 1) involves the submission of a particular secret sign a plurality of times. The secret sign may be successively entered into PDA 32 of FIG. 2B or any other digital handwriting entry system. For each time the secret sign is entered, a set of value ranges for the predetermined features of the secret sign is recorded.

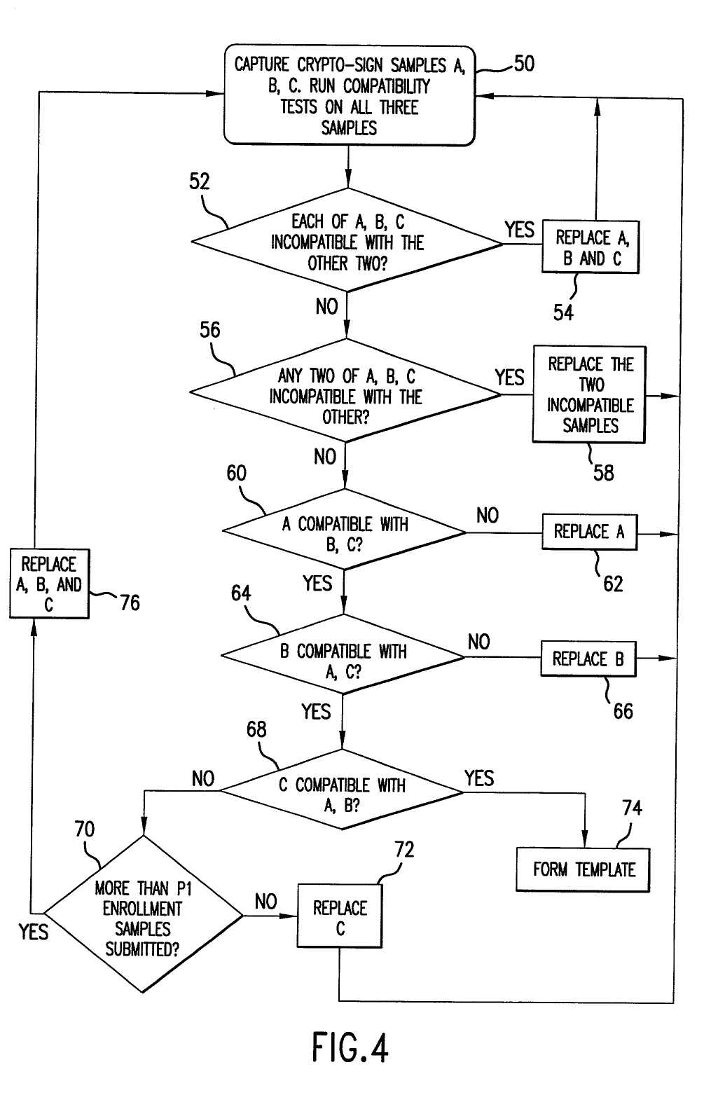

In an example where three secret sign samples A, B, and C are entered, three sets of feature sets are recorded: A₁ . . . Aₙ; B₁ . . . Bₙ; and C₁ . . . Cₙ. FIG. 4 is a flowchart showing the steps for the formation of the secret sign template. Secret sign samples A, B, and C are entered sequentially at step 50. At step 52, secret sign sample A is compared against secret sign samples B and C. Then, secret sign sample B is compared against secret sign sample A and sample C. Finally, in this example, secret sign sample C is compared against secret sign samples A and B. This comparison is given in further detail in following paragraphs.

If sample A is compatible with samples B and C, sample B is compatible with samples A and C, and sample C is compatible with samples A and B, then the secret sign template values are stored in the secret sign template in step 74. If any one of samples A, B, or C is incompatible with the other two secret signs, it is rejected and another secret sign entry is prompted. The same test as described above is then applied to the new set of three secret sign samples. As shown in FIG. 4, if it is determined that one of samples A, B, or C is incompatible with the other two secret sign samples, in steps 60, 64, and 68 respectively, then the respective secret sign is replaced in the respective step 62, 66, or 72 and the compatibility test of step 50 is reapplied.

If it is determined that any two of the three secret sign samples, A, B, or C are incompatible with the other sample (step 56), these two samples are rejected and another two secret sign samples are prompted (step 58). The flow then passes back to step 50 where the compatibility test is then applied to the new set of three secret sign samples. If it is determined in block 52 that all three samples are incompatible with one another, they are rejected and another set of three secret sign samples is prompted in block 54 and the flow passes to block 50 where the same compatibility test is applied to the three new samples.

In the example of FIG. 4, the compatibility test result of sample A compared with samples B and C is tested in step 60 and if found non-compatible, sample A is replaced in block 62. Next, if compatibility is found in step 60, the compatibility test result of sample B compared with samples A and C is tested in step 64 and if found non-compatible, is replaced in step 66. Lastly, if compatibility is found in step 64, the compatibility test results of sample C compared with samples A and B is tested step 68 and if C is found to be compatible then the template values are formed and stored at step 74. If sample C is found to be non-compatible with samples A and B, then the process passes to decision block 70.

A “failure to enroll” flag will be set in the template if no enrollment has occurred after a predetermined number (P1) of secret sign entries. The value for P1 may be chosen by the user or may be permanently set. If more than P1 enrollment entries have been submitted, then the process passes to block 76 to prompt for entry of three new secret signs followed by flow back to block 50 to test the samples. If fewer than P1 enrollment entries have been entered, then the process forwards to step 72 where sample C is replaced and the compatibility tests are rerun in block 50.

Preferably, the secret sign template is subsequently updated after each acceptable authentication of a secret sign entry (defined by a threshold value as part of the template) and the system will be able to attach a timestamp and a template authentication code, based upon a suitable encryption technique and/or secret key, which is securely controlled by the system architecture. A template record may consist of the following fields: user identity; password; valid secret sign data set #1; valid secret sign data set #2 . . . valid secret sign data set #n; secret sign features; maximum number of secret sign enrollment attempts P₁; minimum difference value P₂; enrollment security threshold P₃; comparison security threshold P₄; secondary test threshold P₅; template update threshold P₆; additional system parameters Pⱼ; timestamp at secret sign creation time or last update time; number of secret signs contributing to the template (including updates) if less than n; and a template authentication code.

The template authentication and encryption method should be shared by both the PDA (or PC client) and the template server so that the templates, encrypted by one system can be decrypted by the other. One method of doing this is to use a combination of symmetric secret keys with an algorithm such as the advanced encryption standard (AES) together with a public key infrastructure (PKI) method using asymmetric keys.

Consider Af₁ . . . Afₙ and Bf₁ . . . Bfₙ as defining the feature values of secret sign samples A and B. In order to compare the defining feature values for secret sign sample C against the samples A and B, first we must calculate:

$$\frac{( {Af}_{i} + {Bf}_{i} )}{2} = μ {AB}_{i} for all i = 1 … n .$$

Next we calculate:

$$\frac{\underline{1}}{\sqrt{2}} \vert {Af}_{i} - {Bf}_{i} \vert = {SDAB}_{i} for all i = 1 … n ,$$

where SD represents the template standard deviation estimate for feature i.

If any Afᵢ=Bfᵢ, then Afᵢ−Bfᵢ is set equal to P2, where P2 is a minimum difference value determined empirically after feature definition.

The compatibility test is accepted if

$${\sum }_{i} \frac{\vert μ {AB}_{i} - {Cf}_{i} \vert}{{SDAB}_{i}} \leq ( n + P3 \sqrt{n} )$$

where P3 is an enrollment security threshold set by the security administrator. This comparison is then repeated when comparing sample A against samples B and C and when comparing sample B against samples A and C. A template is formed when all samples are found to be mutually compatible, following the above procedure.

After a compatible template has been formed, referring to FIG. 1, secret sign values are measured at step 26 and at step 28 the measured secret sign values are compared against the value ranges stored in the secret sign template. The secret sign will be accepted if:

$${\sum }_{i} \frac{\vert {X}_{i} - {μ}_{i} \vert \cdot {W}_{i}}{{SD}_{i}} < T , \\ where$$

$$T = n + {P}_{4} \sqrt{{\sum }_{i} {W}_{i}^{2}} , and$$

Xᵢ is the secret sign feature value for feature i(i=1 . . . n), Wᵢ are the discriminating weights with Wᵢ>0 for all i and Σ Wᵢ=n and μi being the current template mean estimate for feature i. Further, SDᵢ is current template standard deviation estimate for feature i. Parameter P₄, the comparison security threshold, is set by the security administrator.

The feature set will contain time-based features as well as spatial features. In a dynamic signature verification system, where the signature is known to a potential forger, who may also have observed the author signing, it is possible, through practice, that he may be able to generate a credible signature, acceptable to the system. In a secret sign system, although it will be much more difficult to guess both the spatial and timing features of the sign, a forger, through observation, may be better able to estimate the timing of the sign rather than its spatial qualities. It is for this reason that it is very important in the instant method of the secret sign system, that the spatial characteristics should be given precedence over timing characteristics. This can be accomplished by making a secondary test of just the spatial features in situations where the full test is marginal. The “accept” decision would now have to satisfy, in addition to the first test, a second test where, for example,

$${\sum }_{i} \frac{\vert {X}_{i} - {μ}_{i} \vert \cdot {W}_{i}}{{SD}_{i}} < {P}_{5} ,$$

for spatial features where P₅ is the secondary test threshold.

The secret sign template feature values are updated, as shown in FIG. 1, if:

$${P}_{6} ⟨ {\sum }_{i} \frac{\vert {X}_{i} - {μ}_{i} \vert \cdot {W}_{i}}{{SD}_{i}} ⟨ T ,$$

where P₆ is the template updated threshold.

The new template value for feature i is equal to:

K·(old template value)+(1−K)·(new feature value),

and the new template SD for feature i equal to:

K·(old template SD)+(1−K)·|(new feature value−old template value)|,

where 0<K<1.

The processor of PDA 32, or of general system 10, then calculates a one-time secret key, which it uses to encrypt the data to be communicated. The advanced encryption standard (AES) algorithm, or a similar encryption algorithm, could be used for this purpose. The device then encrypts the secret key with the public key of the destination host and communicates the data to that host with the encrypted secret key. On receipt of that data, the host decrypts the secret key using its own private key and then uses the secret key so generated to decrypt the message/template. The template is updated and stored in AES, or a similar encrypted form.

In the system shown in FIG. 2B, PDA 32 would decrypt the template, check the ID number and authentication code, compare the secret sign with the template value, update the template and release the encrypted or decrypted valid signature data which could be stored on remote processor 38, to the application. The same encryption system, combining symmetric and asymmetric key pairs would be used to secure the data transmission and storage of the template on processor 38. Further, a separate authentication storage code is created from the template data and may be used as a check sum.

In a system having a separate template server, the data could be communicated from a local client or PDA 32 to a server in encrypted form. These data could be the raw secret sign data or they could be the counts generated from the raw secret sign data. The server would be responsible for the feature generation and decision-making.

In a system where the template is held on a smart card, such as in FIG. 2C, the logic processing can be preformed on a local client or processor 82, or a separate smart card reader. The verification/encryption/storage/updating may take place on the smart card itself. Alternatively, those procedures could take place in the card reader, in processor 82, or in remote processor 80, with mutual device authentication enabled between the card and the card reader or processor 82, and encryption enabled between the processor 82 and the template storage 86 or 86′, so that the sign “accept” message is encrypted between them. The preferred encryption method would employ a combination of symmetric keys and private/public PKI keys. A successful secret sign authentication could release a private encryption key to encrypt a message stored on the smart card for transmission.

Further, the secret sign may be used for authentication and security purposes other than the appending of a digital representation of a signature to an electronic document. The use of secret sign authentication as defined herein, using the local template, may replace use of a standard password or PIN on a PDA or other device or system, to gain access to sensitive data/transactions to utilize one's debit/credit card in payment systems, or use the computing device at all, i.e. as when the operating system is “locked out” when secret sign authentication is not obtained. Failure to authenticate, using this method, after a certain number of attempts would result in an output command to destroy the template and require the user to re-enroll with the security administrator/equipment manufacturer.

Although this invention has been described in connection with specific forms and embodiments thereof, it will be appreciated that various modifications other than those discussed above may be resorted to without departing from the spirit or scope of the invention. For example, functionally equivalent elements or method steps may be substituted for those specifically shown and described and in the method steps described, particular steps may be reversed or interposed all without departing from the spirit or scope of the invention as defined in the appended claims.

What is claimed is:

1. A method of authenticating a digitized signature for execution of an electronic document, comprising the steps of:
(a) establishing a digital representation of a user's valid signature;
(b) storing said digital representation of said valid signature;
(c) establishing a secret sign, said secret sign being known only to the user;
(d) creating a template of value ranges for predetermined features of said secret sign;
(e) electronically storing said template;
(f) providing an electronic document for execution by the user;
(g) hand writing said secret sign on a signature entry device;
(h) measuring values of said predetermined features for said handwritten secret sign;
(i) comparing said measured values with said value ranges of said template to authenticate said secret sign; and,
(j) appending a copy of said digital representation of said user's valid signature to said electronic document responsive to authentication of said secret sign.

2. The method of authenticating a digitized signature for execution of an electronic document as recited in claim 1 wherein said predetermined features of said secret sign include functions of stylus coordinate values.

3. The method of authenticating a digitized signature for execution of an electronic document as recited in claim 1 wherein said predetermined features of said secret sign include functions of pressure values corresponding to a set of stylus coordinate values.

4. The method of authenticating a digitized signature for execution of an electronic document as recited in claim I wherein said step of creating a template includes the step of encrypting said value ranges.

5. The method of authenticating a digitized signature for execution of an electronic document as recited in claim 1 further includes the step of updating said value ranges of said template following the step of authentication of said secret sign.

6. The method of authenticating a digitized signature for execution of an electronic document as recited in claim 1 wherein said step of creating a template includes the step of adding an authentication code.

7. The method of authenticating a digitized signature for execution of an electronic document as recited in claim 1 wherein said step of creating a template includes the step of adding an electronic time stamp.

8. The method of authenticating a digitized signature for execution of an electronic document as recited in claim 7 wherein each subsequent authentication of said secret sign is followed by a step of updating said electronic time stamp.

9. The method of authenticating a digitized signature for execution of an electronic document as recited in claim 5 wherein the step of updating said template is followed by a step of recording the number of times said value ranges are updated.

10. The method of authenticating a digitized signature for execution of an electronic document as recited in claim 1 wherein said step of hand writing said secret sign includes the step of inhibiting display of said secret sign as it is being written.

11. The method of authenticating a digitized signature for execution of an electronic document as recited in claim 1 wherein said step of creating a template includes the step of entering a set of samples of said predetermined feature values of said secret sign, each member of said set being compared to each of other members of said set.

12. A system for authenticating a digitized signature for execution of an electronic document, comprising:
a signature storage medium having a digital representation of a user's valid signature stored therein;
a handwriting entry device for receiving and digitizing a secret sign known only to a user;
a template storage medium for storing a set of value ranges for predetermined features of an authentic secret sign;
a processor in electrical communication with said handwriting entry device, said template storage medium and said signature storage medium, said processor comparing values for said predetermined features of said digitized secret sign and said set of value ranges for said predetermined features of said authentic secret sign to authenticate said digitized secret sign, said processor appending said digital representation of the user's valid signature to an electronic document responsive to said authentication of said digitized secret sign.

13. The system for authenticating a digitized signature for execution of an electronic document as recited in claim 12 wherein said template storage medium is located on a smart card.

14. The system for authenticating a digitized signature for execution of an electronic document as recited in claim 12 wherein said processor is located on a smart card.

15. The system for authenticating a digitized signature for execution of an electronic document as recited in claim 13 wherein said processor is in electrical communication with a smart card reader and said smart card is received within said smart card reader.

16. The system for authenticating a digitized signature for execution of an electronic document as recited in claim 12 wherein said handwriting entry device includes a display coupled to said processor for prompting an entry of said secret sign, said display being inhibited from displaying said secret sign as it is entered by said processor.

17. The system for authenticating a digitized signature for execution of an electronic document as recited in claim 12 wherein said signature storage medium and said template storage medium are provided in a common storage device.

18. The system for authenticating a digitized signature for execution of an electronic document as recited in claim 12 wherein said handwriting entry device is a personal digital assistant.

19. A method of verifying access rights to an electronic system, comprising the steps of:
(a) establishing a secret sign for a user, said secret sign being known only to the user;
(b) creating a template of value ranges for predetermined features of said secret sign;
(c) electronically storing said template;
(d) hand writing said secret sign on a signature entry device;
(e) measuring values of said predetermined features for said handwritten secret sign;
(f) comparing said measured values with said value ranges of said template to authenticate said secret sign; and
(g) granting the user access to the electronic system responsive to authentication of said secret sign.

20. The method of authenticating a secret sign for electronic system access as recited in claim 19 wherein said step of creating a template includes the step of encrypting said value ranges.

21. The method of authenticating a secret sign for electronic system access as recited in claim 19 further includes the step of updating said value ranges of said template following the step of authentication of said secret sign.

22. The method of authenticating a secret sign for electronic system access as recited in claim 19 wherein said step of creating a template includes the step of adding an authentication code.

23. The method of authenticating a secret sign for electronic system access as recited in claim 19 wherein said step of creating a template includes the step of adding an electronic time stamp.

24. The method of authenticating a secret sign for electronic system access as recited in claim 23 wherein each subsequent authentication of said secret sign is followed by a step of updating said electronic time stamp.

25. The method of authenticating a secret sign for electronic system access as recited in claim 21 wherein the step of updating said template is followed by a step of recording the number of times said value ranges are updated.

26. The method of authenticating a secret sign for electronic system access as recited in claim 19 wherein said step of hand writing said secret sign includes the step of inhibiting display of said secret sign as it is being written.

27. The method of authenticating a secret sign for electronic system access as recited in claim 19 wherein said step of creating a template includes the step of entering a set of samples of said predetermined feature values of said secret sign, each member of said set being compared to each of other members of said set.
